(19) United States
(12) Patent Application Publication
(10) Pub. No.: US 2008/0202559 A1
(43) Pub. Date: Aug. 28, 2008

(54) Wafer cleaning method and equipment

(75) Inventors: Kunihiro Miyazaki, Yokohama-shi (JP); Takashi Higuchi, Kyoto-shi (JP); Toshiki Nakajima, Suwa-shi (JP); Hiroyuki Matsuo, Chino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: Kabushiki Kaisha Toshiba Dainippon Screen Mfg.Co., Ltd.; Seiko Epson Corporation

(21) Appl. No.: 12/081,460

(22) Filed: Apr. 16, 2008

Related U.S. Application Data
(62) Division of application No. 10/932,006, filed on Sep. 2, 2004.

(30) Foreign Application Priority Data
Sep. 5, 2003 (JP) 2003-314513

(51) Int. Cl. B08B 3/04

(52) U.S. Cl. 134/18

(57) ABSTRACT

There is disclosed a wafer cleaning method comprising supplying a cleaning water to a wafer cleaned with a chemical solution, measuring the resistivity of a solution including the chemical solution and cleaning water, and differentiating the measured value with respect to time, and cleaning the wafer continuously with the cleaning water until the time differential value of the resistivity becomes equal to or less than a preset value and is held at that values for preset time.

### CROSS-REFERENCE TO RELATED APPLICATIONS

This application is based upon and claims the benefit of priority from prior Japanese Patent Application No. 2003-314513, filed Sep. 5, 2003, the entire contents of which are incorporated herein by reference.

### BACKGROUND OF THE INVENTION

1. Field of the Invention

The present invention relates to a wafer cleaning process. More particularly, the invention relates to a wafer cleaning method and equipment in a final wafer cleaning process using cleaning water after cleaning chemical a wafer with a chemical solution.

2. Description of the Related Art

Variety of measures are taken to protect a wafer against contamination during a semiconductor manufacturing process and other unexpected contamination for improving the characteristics and yield of semiconductor elements provided on a wafer. Generally, a wafer is cleaned with a chemical solution. Common chemical solutions used for cleaning a wafer include a mixed water solution of hydrochloric acid and hydrogen peroxide, a mixed water solution of ammonia and hydrogen peroxide, and a mixed solution of dense sulfuric acid and hydrogen peroxide. A water solution of hydrofluoric acid is also commonly used. Recently, a mixed water solution of hydrofluoric acid and ozone water or a mixed water solution of hydrofluoric acid and hydrogen peroxide is also used.

A wafer cleaning method is roughly divided into the following two types. One is a method of immersing a plurality of wafers in a processing tank filled with a chemical solution. This is so-called a batch cleaning method. The other is a method of supplying a chemical solution to the surfaces of a plurality of wafers by rotating one by one. This is so-called a single wafer cleaning method.

After the chemical cleaning, eliminate the chemical solution adhered to a wafer by using ultra-pure water, and dry a wafer. Then, go to the next semiconductor manufacturing process. If it is difficult to eliminate the impurities adhered to a wafer with one kind of chemical solution, use two or more kinds of chemical solutions and continue cleaning a wafer using each chemical solution. Insert a rinse step using ultra-pure water into the wafer cleaning process using chemical solutions. At the end of the cleaning process, eliminate sufficiently the chemical solution adhered to a wafer by final rinse with ultra-pure water, and dry a wafer. This final rise with ultra-pure water aims at eliminating sufficiently the chemical solution adhered to a wafer.

However, it is impossible to know directly the end of the rinsing at which the chemical solution adhered to a wafer is sufficiently eliminated. In the batch cleaning method, the end of rinsing (the rinsing time) is generally determined based on the density of a specified ion included in the chemical solution existing in the liquid in the processing tank. Concretely, measure the ion density of a chemical solution by monitoring the resistivity or the reciprocal number thereof, conductivity of the solution flowed out from the processing tank during the final rinse step. When the measured ion density of a chemical solution is equal to or less than the value indicating that the chemical solution adhered to a wafer is sufficiently eliminated, the final rinse step is regarded completed. The value indicating that the chemical solution adhered to a wafer is sufficiently eliminated is generally determined by experiments. Though, unlike the wafer cleaning method, as a method of controlling the resistivity in an equipment of refining ultra-pure water used for cleaning a wafer, the technique using the resistivity end point, as well as the method of deciding the rise time, is disclosed in Jpn. Pat. Appln. KOKAI Publication No. 9-1138.

### BRIEF SUMMARY OF THE INVENTION

According to an aspect of the invention, there is provided a wafer cleaning method comprising: supplying a cleaning water to a wafer cleaned with a chemical solution; measuring the resistivity of a solution including the chemical solution and cleaning water, and differentiating the measured value with respect to time; and cleaning the wafer continuously with the cleaning water until the time differential value of the resistivity becomes equal to or less than a preset value and is held at that values for preset time.

According to another aspect of the invention, there is provided a wafer cleaning method comprising: supplying a cleaning water to a wafer cleaned with a chemical solution; measuring the conductivity of a solution including the chemical solution and cleaning water, and differentiating the measured value with respect to time; and cleaning the wafer continuously with the cleaning water until the time differential value of the conductivity becomes equal to or more than a preset value and is held at that values for preset time.

According to another aspect of the invention, there is provided a wafer cleaning equipment comprising: a cleaning tank which contains a wafer cleaned with a chemical solution; a cleaning water supplying unit which supplies the cleaning tank with a cleaning water to clean the wafer; an electric characteristic measuring unit which measure the resistivity of a solution including the cleaning water and the chemical solution used for cleaning the wafer; an arithmetic unit which differentiates with respect to time the resistivity of the solution measured with the electric characteristic measuring unit; and a control unit which operates the cleaning water supplying unit and supplies the cleaning water to the cleaning tank, until the time differential value of the resistivity calculated by the arithmetic unit becomes equal to or less than a preset value and is held at that value for preset time.

According to still another aspect of the invention, there is provided a wafer cleaning equipment comprising: a cleaning tank which contains a wafer cleaned with a chemical solution; a cleaning water supplying unit which supplies the cleaning tank with a cleaning water to clean the wafer; an electric characteristic measuring unit which measures the conductivity of a solution including the cleaning water and the chemical solution used for cleaning the wafer; an arithmetic unit which differentiates with respect to time the conductivity of the solution measured with the electric characteristic measuring unit; and a control unit which operates the cleaning water supplying unit and supplies the cleaning water to the cleaning tank, until the time differential value of the conductivity calculated by the arithmetic unit becomes equal to or more than a preset value and is held at that value for preset time.

### BRIEF DESCRIPTION OF THE SEVERAL VIEWS OF THE DRAWING

FIG. 1 is a flowchart showing a wafer cleaning method according to a first embodiment;

FIG. 2 is a simplified block diagram showing a wafer cleaning equipment according to a first embodiment;

FIG. 3 is a graph showing the relationship between the time of cleaning the wafer according to a first embodiment and the time differential values of the resistivity for each kind of cleaning chemical solutions and the number of wafers to be cleaned;

FIG. 4 is a simplified block diagram showing a wafer cleaning equipment according to a second embodiment;

FIGS. 5A and 5B are sectional views showing a simplified wafer cleaning equipment according to a prior art;

FIG. 6 is a graph showing the relationship between the time of cleaning a wafer and the resistivity according to a prior art; and

FIG. 7 is a graph showing the relationship between the time of cleaning a wafer and the resistivity according to a prior art for each kind of cleaning chemical solutions and the number of wafers to be cleaned.

### DETAILED DESCRIPTION OF THE INVENTION

Hereinafter the present invention will be explained in detail according to embodiments shown in the accompanying drawings.

### 1st. Embodiment

Before explaining the embodiment, description will be given on a method of measuring the resistivity of a common solution according to a prior as an example comparative to the embodiment, with reference to FIG. 5A-FIG. 7.

A method of measuring the resistivity of a common conventional solution uses two types of cleaning equipments 101 and 102 shown in FIG. 5A and FIG. 5B. In the method using the cleaning equipment 101 shown in FIG. 5A, a resistivity measuring cell (a resistivity meter) 106, which monitors the resistivity of the solution 105, is provided in proximity to an upper opening 104a of a tank 104 containing a wafer 103. The resistivity measuring cell 106 measures the resistivity of the solution 105 overflowed from the upper opening 104a. In the method using the cleaning equipment 102 shown in FIG. 5B, a port 108 is provided at the middle of the tank 107 to extract the solution 105 from the tank 107, and the resistivity measuring cell 106 is provided at the port 108. The resistivity measuring cell 106 measures the resistivity of the sampling solution 105 extracted from the tank 107 through the port 108. As the tanks 104 and 107, it is common to use a rinse tank for rinsing the wafer 103 with adhesion of a chemical solution, or a processing tank with a mechanism to replace pure water for the solution supplied to the tank, after the wafer 103 is cleaned with a chemical solution in the tank.

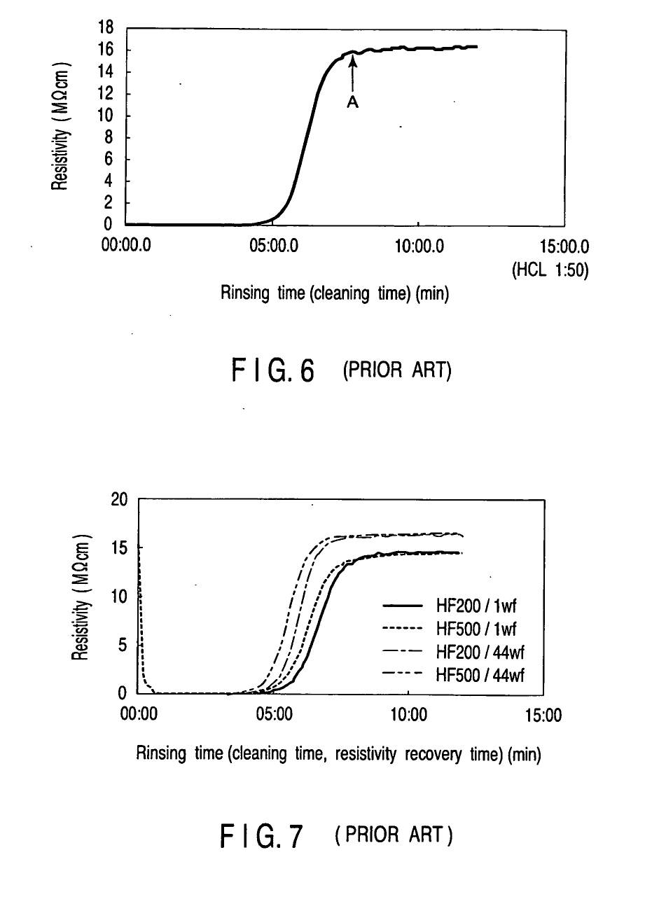

FIG. 6 shows an example of the changes with time of the resistivity of the solution 105 measured by the method shown in FIG. 5A. Usually, measure the changes with time of the resistivity at least once and obtain the data as shown in FIG. 6. If the resistivity rises and becomes stable at a certain value, the chemical solution in the tank 104 is regarded as almost completely replaced by pure water. In the example shown in FIG. 6, the final rising time is set to 10 minutes. In this case, the resistivity of the solution 105 is substantially stabilized at approximately 16 MΩcm about 2 minutes after stop of rising. Namely, the chemical solution in the tank 104 is regarded as almost completely replaced by pure water and the chemical solution adhered to the wafer 103 is regarded sufficiently eliminated. The rinsing time is usually set with sufficient allowance as described above.

In recent years, however, semiconductor devices have been marketed at a low price, and mass production of semiconductor devices with reduced costs has been demanded. Thus, the rinsing time has been reduced by decreasing the pure water volume in cleaning a wafer, or by reducing the time required by cleaning a wafer. For example, in the above-mentioned cleaning method of determining the final wafer rinsing time by measuring the resistivity of solution, the rinsing is finished at the point when the resistivity reaches a preset value. In FIG. 6, when the resistivity of the solution 105 rises equal to or more than 16 MΩcm, the wafer rinsing is regarded as finished. Therefore, in this case, the end of rinsing is set at the point when the resistivity of the solution 105 reaches the point A indicated by the solid arrow mark in FIG. 6.

In the wafer cleaning method of finishing the rinsing at the point when the resistivity of solution reaches a preset value, there are problems that the rinsing time varies with the kinds and density of solution or the number of wafers to be processed, and the resistivity does not reach a preset value. Thus, it has been practically difficult to use a wafer cleaning equipment which is incorporated with a system adopting the above cleaning method. Particularly, in the method (equipment) shown in FIG. 5A, so-called air involving occurs, and carbonic acid gas, etc. in the air is easily dissolved in the solution 105 overflowed from the upper opening 104a of the tank 104. If carbonic acid gas such as carbon dioxide is dissolved in the solution 105, a noise occurs in the cleaning system of the cleaning equipment 101, and the resistivity of the solution 105 is lowered. In addition, in the method (equipment 101) shown in FIG. 5A, the area of the solution 105 contacting the air varies (the surface fluctuates) and the dissolved amount of the carbonic acid gas in the solution 105 varies easily, the noise in the cleaning system is easy to change.

In the conventional wafer cleaning methods, it is difficult to measure stably and accurately whether the resistivity (conductivity) of solution reaches a preset value. Namely, it is difficult to determine stably and accurately whether a chemical solution or stains adhered to a wafer is completely eliminated and a wafer is cleaned to the proper clean state. It is further difficult to improve the efficiency of cleaning a wafer by decreasing the volume of pure water used for cleaning a wafer, or reducing the cleaning time. If semiconductor elements are mounted on a wafer contaminated by the chemical solution not completely eliminated, the characteristics and yield of the semiconductor elements will be lowered. Namely, a semiconductor device using a contaminated wafer will have low performance, quality, reliability and yield. Such a semiconductor device will also have low production efficiency, and increase production costs.

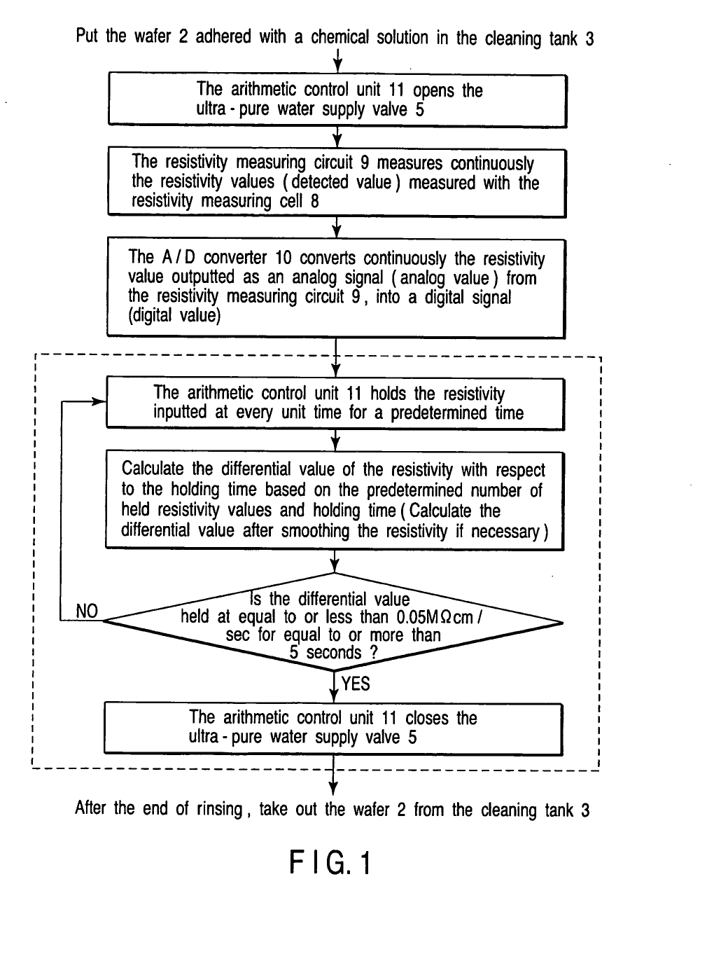

This embodiment has been made to solve the above problems. It is an object of the embodiment to provide a wafer cleaning method and equipment which can clean a wafer to the proper clean state while increasing the cleaning efficiency regardless of the number of wafers to be cleaned, and the kinds and density of chemical solution. It is another object of the embodiment is to provide a wafer which is completely cleaned to the proper clean state with no chemical solution remained, and a semiconductor device which is provided with such a clean wafer and improved in the performance, quality, reliability and yield. Hereinafter the first embodiment of the invention will be explained in details with reference to FIG. 1-FIG. 3.

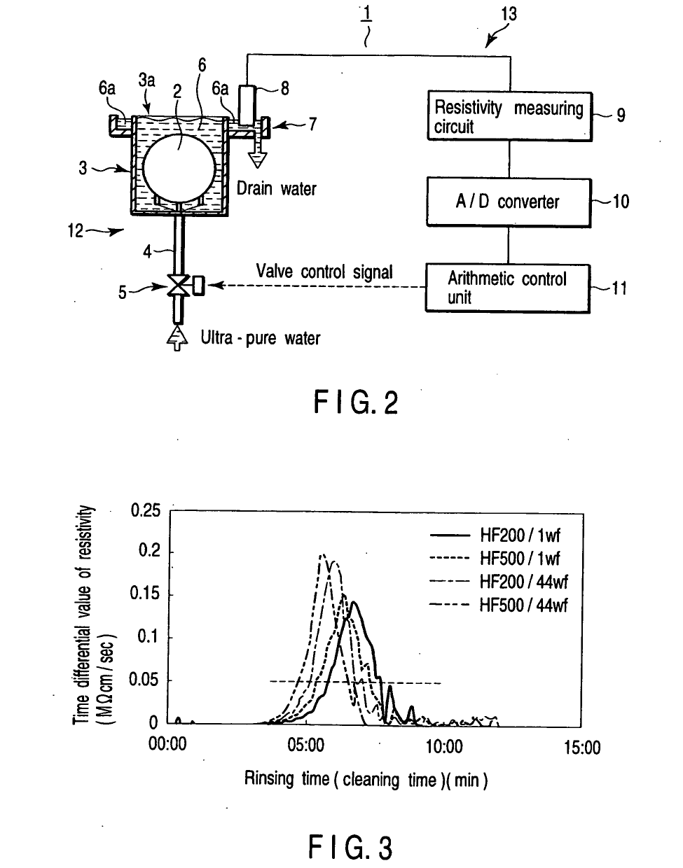

FIG. 1 is a flowchart showing a wafer cleaning method according to this embodiment. FIG. 2 is a simplified block diagram showing a wafer cleaning equipment according to this embodiment. FIG. 3 is a graph showing the relationship between the rinsing (cleaning) time of the wafer according to this embodiment and the time differential value of the resistivity for each kind of cleaning chemical solution and the number of wafers.

This embodiment defines the end time of the final rinsing after cleaning a wafer with a chemical solution, to reduce the volume of cleaning water and net rinsing time (Row Process Time: RPT) in the wafer cleaning process, and cleans a wafer to the proper clean state. Concretely, the pure water resistivity (conductivity) of the solution including the cleaning water is continuously monitored during the final rinsing in order to define the end of final wafer rinsing. The obtained resistivity data is differentiated to obtain the change in the inclination with time. Then, the end point of rinsing is determined based on the inclination change with time and the continued final rinsing time. The method reduces the cleaning water volume and RPT in this way, and cleans a wafer to the proper clean state. Detailed explanation will be given below.

First, explanation will be given on a wafer cleaning equipment 1 according to this embodiment with reference to FIG. 2. The cleaning equipment 1 has a cleaning tank 3 which contains one or more wafers 2 cleaned with a chemical solution. The cleaning tank 3 may be either a processing tank dedicated to rinsing the wafer 2 with adhesion of a cleaning chemical solution, or a processing tank provided with a device to switch the solution supplied to the wafer 2 from a chemical solution to cleaning water after the wafer 2 is cleaned with a chemical solution. The bottom of the cleaning tank 3 is connected to a water supply pipe 4 which supplies a cleaning water used for rinsing the wafer 2 to the inside of the cleaning tank 3. At the middle of the water supply pipe 4, a cleaning water supply valve 5 is provided as a cleaning water supply device to supply a cleaning water to the inside of the cleaning tank 3. In this embodiment, ultra-pure water is used as a cleaning water. Therefore, the cleaning water supply valve can also be called an ultra-pure water supply valve 5.

The cleaning tank 3 has an opening 3a at the top. The chemical solution adhered to the wafer 2 and the solution 6 including the pure water supplied to the inside of the cleaning tank 3 overflow from the inside to outside of the cleaning tank through the opening 3a. Provided near the opening 3a of the cleaning tank 3 is a drain port 7 to drain the solution 6 to the outside of the cleaning tank 3 after once receiving the solution 6 overflowed from the inside of the cleaning tank 3. An electric character measuring unit 8 which measures the resistivity or conductivity of the solution 6 is provided contacting the solution 6 in the drain port 7.

The resistivity and conductivity are reciprocal to each other. Therefore, measurement of at least one of the resistivity and conductivity of the solution 6 corresponds to measurement of the other. In this embodiment, the resistivity of the solution 6 is to be measured with the electric characteristic measuring unit 8. Therefore, in this embodiment, a resistivity meter (resistivity measuring cell) 8 is used as an electric characteristic measuring unit. The resistivity measuring cell 8 measures, as the resistivity of the solution 6, the resistivity of the overflowed water 6a drained from the inside to outside of the cleaning tank 3 through the opening 3a at the top of the cleaning tank 3.

The resistivity of the solution 6 measured with the resistivity measuring cell 8 is sent to a resistivity measuring circuit 9 as an electric signal. The resistivity measuring circuit 9 measures the resistivity of the solution 6 that is measured with the resistivity measuring cell 8, based on the electric signal output from the resistivity measuring cell 8.

The resistivity of the solution 6 measured with the resistivity measuring circuit 9 is sent from the resistivity measuring circuit 9 to an A/D converter 10 as an electric signal. In this embodiment, the resistivity measuring circuit 9 is set to output the measured resistivity of the solution 6 as an analog signal. An arithmetic control circuit 11 is set to receive a digital signal. Therefore, in this embodiment, the A/D converter 10 is set to convert an analog signal output from the resistivity measuring circuit 9 to a digital signal, and send this digital signal to the arithmetic control circuit 11.

The resistivity of the solution 6 converted from analog to a digital signal with the A/D converter 10 is sent to the arithmetic control unit 11. The arithmetic control unit 11 obtains the resistivity of the solution 6 measured with the resistivity measuring circuit 9 at every preset time, holds it for preset time, differentiates the obtained measured value with respect to time, and controls open/close of the ultra-pure water supply valve 5. In this embodiment, the arithmetic control unit 11 consists of an arithmetic unit (arithmetic section, arithmetic circuit) which differentiates with respect to time the resistivity of the solution 6 measured with the resistivity measuring cell 8, and a control unit (control section, control circuit) which is integrated with the arithmetic unit, and supplies a cleaning water to the cleaning tank 3 by operating the ultra-pure water supply valve 5 until the differential value calculated by the arithmetic unit becomes equal to or less than a preset value and is held at that value for preset time.

The cleaning tank 3, water supply pipe 4 and ultra-pure water supply valve 5 constitute a cleaning system 12 of the cleaning equipment 1. The resistivity measuring cell 8, resistivity measuring circuit 9, A/D converter 10 and arithmetic control unit 11 constitute a measuring system 13 of the cleaning equipment 1.

Next, explanation will be given on a wafer cleaning method according to this embodiment with reference to FIG. 1. The wafer cleaning method of this embodiment is concretely a cleaning method in the final wafer rinsing process, which eliminates stains such as chemical solution adhered to the wafer 2 cleaned with a chemical solution, and clean the wafer 2 to the proper clean state. The wafer cleaning method of this embodiment measures the resistivity of the chemical solution used for cleaning the wafer 2 and the solution 6 including the cleaning water used for rinsing the wafer 2 cleaned with the chemical solution, and differentiates the measured value with respect to time. The wafer 2 is continuously rinsed until the differentiated value becomes equal to or less than a preset value and held at that value for preset time. In the wafer cleaning method of this embodiment, the wafer 2 is rinsed by using the wafer cleaning equipment 1. Detailed explanation will be given below.

First, put one or more wafers 2 in the cleaning tank 3 in the stat that the wafer is cleaned but the cleaning solution is not completely eliminated. Next, open the ultra-pure water supply valve 5 by sending a valve control signal to open the ultra-pure water supply valve 5 from the arithmetic control unit 11 to the ultra-pure water supply valve 5. The ultra-pure water is supplied to the inside of the cleaning tank 3, and the wafer 2 is begun to be cleaned with ultra-pure water (rinsed with ultra-pure water). At the same time, the resistivity measuring cell 8 starts measuring the resistivity of the solution 6 (overflowed water 6a) drained from the cleaning tank 3. The resistivity measuring circuit 9 measures continuously the value (detected value) measured with the resistivity measuring cell 8. The A/D converter 10 converts continuously the resistivity value outputted as an analog signal (analog value) from the resistivity measuring circuit 9, into a digital signal (digital value). The A/D converter 10 outputs the digital signal to the arithmetic control unit 11.

The arithmetic control unit 11 receives the digital signal output from the A/D converter 10, and performs a predetermined processing based on the digital signal. The predetermined processing performed by the arithmetic control unit 11 is indicated by a dashed line in FIG. 1. Detailed explanation will be given below.

First, hold the resistivity value inputted as a digital signal to the arithmetic control unit 11 at every preset time for preset time predetermined by the arithmetic control unit 11. Next, the arithmetic control unit 11 calculates the inclination (change rate), or the differential value of the resistivity with respect to the holding time, based on the held number of resistivity values and the holding time. The differential value can be calculated after smoothing the resistivity values, if necessary. The differential value of the resistivity corresponds to the inclination of the resistivity at a predetermined time. Thus, it is also permitted to obtain the inclination by smoothing real time the predetermined number of held resistivity data before holding the resistivity data held for obtaining the differential value. A method and degree of smoothing is not specified as long as noises in the cleaning system 12 and measuring system 13 of the cleaning equipment 1 are taken into account. A weighted average (a weighted smoothing), a weighted mean, or Savizky-Golay method is permitted.

Next, determine by the arithmetic control unit 11 whether the differential value obtained by the arithmetic control unit 11 is equal to or less than a preset value and held at that value for preset time. When the differential value is equal to or less than the preset value and held at that value for the preset time, the stains such as a chemical solution adhered to the wafer 2 is regarded as completely eliminated, and the wafer 2 is regarded as cleaned to the proper clean state. In this embodiment, the arithmetic control unit 11 is set to determine whether the differential value is equal to or less than 0.05 MΩcm/sec and held at that value for equal to or more than 5 seconds after passing the maximum value. When the differential value is equal to or less than 0.05 MΩcm/sec and held at that value for equal to or more than 5 seconds after passing the maximum value, the wafer 2 is regarded as cleaned to the proper clean state, and rinsing the wafer 2 with ultra-pure water is finished.

The above differential value measuring condition is set to an appropriate value according to the cleanness demanded for the wafer 2. The value of the condition is previously obtained by experiments. The ideal timing to finish the rinsing with ultra-pure water is a point when the differential value of the resistivity reaches 0.00 MΩcm/sec, or the inclination of the resistivity with respect to time becomes zero. However, noises (electric signal noises) occur in the cleaning system 12 and measuring system 13 of the cleaning equipment 1, and the differential value of the resistivity can not practically reach 0.00 MΩcm/sec. According to the experience and experiments done by the inventors, it is seen that when the differential value of the resistivity is held equal to or less than 0.05 MΩcm/sec for at least 5 seconds after passing the maximum value, the wafer 2 can be cleaned to the proper clean state regardless of the number of wafers and the kinds and density of chemical solution used for cleaning. Therefore, it is set in this embodiment that if the differential value of the resistivity is held equal to or less than 0.05 MΩcm/sec for at least 5 seconds after passing the maximum value, the rinsing the wafer 2 with ultra-pure water is finished.

If the arithmetic control unit 11 determines that the differential value is not held equal to or less than 0.05 MΩcm/sec for equal to or more than 5 seconds after passing the maximum value, rinsing the wafer 2 with ultra-pure water is continued and the arithmetic control unit 11 holds the resistivity data and repeats differentiation of the resistivity based on that data, until the differential value meets that condition. If the data is held repeatedly and the data is held for a long time, the number of held data is increased and the load to the arithmetic control unit 11 is increased. To avoid this, it is permitted to set to abandon the data after the preset time passes.

If the arithmetic control unit 11 determines that the differential value is held equal to or less than 0.05 MΩcm/sec for equal to or more than 5 seconds after passing the maximum, the arithmetic control unit 11 sends a valve control signal which closes the ultra-pure water supply valve 5 to the ultra-pure water supply valve 5, and closes the ultra-pure water supply valve 5. By this action, supply of ultra-pure water to the cleaning tank 3 is stopped, and the ultra-pure water rinsing of the wafer 2 is finished. After the end of ultra-pure water rinsing of the wafer 2, take out the wafer 2 from the cleaning tank 3, and dry the wafer. This completes the final wafer rinsing process.

FIG. 3 is a graph showing that the resistivity data is obtained at every second and held for a second in the cleaning method of one example of this embodiment, and the differential value of the resistivity with respect to the changes with time is calculated based on the held data. In this example, differentiation is performed by obtaining the resistivity data at about every second and holding it for a second, but the data holding time, differential value calculating interval and differential value holding time are not limited to about 1 second. They may be the time sufficiently short against the net time (RPT) required by the rinsing of the wafer 2 with ultra-pure water.

HF200/1 wf in FIG. 3 indicates the ultra-pure water rinsing (final rinsing) of one wafer 2 that is cleaned by using the chemical solution composed of pure water and water solution of 50% hydrofluoric acid, and diluted to have an about 1:200 volume ratio of the water solution of 50% hydrofluoric acid to pure water. The solid line in the graph of FIG. 3 indicates the changes of the time differential value of the resistivity with respect to the ultra-pure water rinsing time in HF200/1wf. HF500/1wf indicates the ultra-pure water rinsing of one wafer 2 that is cleaned by using the chemical solution composed of pure water and water solution of 50% hydrofluoric acid, and diluted to have an about 1:500 volume ratio of the water solution of 50% hydrofluoric acid to pure water. The dashed line in the graph of FIG. 3 indicates the changes in the time differential value of the resistivity with respect to the ultra-pure water rinsing time in HF500/1wf. HF200/44wf indicates the ultra-pure water rinsing of 44 wafers 2 that are cleaned by using the chemical solution composed of pure water and water solution of 50% hydrofluoric acid, and diluted to have an about 1:200 volume ratio of the water solution of 50% hydrofluoric acid to pure water. The chain line in the graph of FIG. 3 indicates the changes in the time differential value of the resistivity with respect to the ultra-pure water rinsing time in HF200/44wf. HF500/44wf indicates the ultra-pure water rinsing of 44 wafers 2 that are cleaned by using the chemical solution composed of pure water and water solution of 50% hydrofluoric acid, and diluted to have an about 1:500 volume ratio of the water solution of 50% hydrofluoric acid to pure water. The chain double-dashed line in the graph of FIG. 3 indicates the changes in the time differential value of the resistivity with respect to the ultra-pure water rinsing time in HF500/44wf.

As seen from the graph of FIG. 3, the differential value (inclination) of resistivity generally shows a curve projecting upward, descending after once rising regardless of the number of wafers 2 and the kinds and density of the cleaning chemical solution. Even if the rinsing time is extended under each of the four conditions, and the differential value 0 of resistivity is not held various due to noise components. Among the four conditions, the peak (maximum) position of differential value and sweep time are largely different. According to the graph of FIG. 3, the differential value of resistivity can take the same value at different points except the peak. FIG. 3 indicates that the resistivity greatly changes until the differential value reaches its peak. While the is resistivity is so changing, the chemical solution is substituted by ultra-pure water. In view of this, it is obviously necessary to keep cleaning the wafer 2 until the differential value reaches the peak in the graph of FIG. 3. Therefore, when the differential value of resistivity reaches a preset value after once reaching the peak, the wafer 2 is regarded as cleaned to the proper clean state.

The differential value of resistivity at which the wafer 2 is regarded as cleaned to the proper clean state may be set to an appropriate value according to the cleanness demanded for the wafer 2 as long as it has once reached the peak. As the above differential value is set smaller, the cleanness of wafer 2 is increased, but the time required to finish the ultra-pure water rinsing becomes long. If the rinsing time with ultra-pure water is long, the row process time (RPT) of rinsing with ultra-pure water becomes long, decreasing the productivity, and increasing the production cost with the increased volume of ultra-pure water.

According to the graph of FIG. 3, it is seen that the part where the differential value sweeps indicates the state that the maximum and minimum differential values are repeated due to the various noise components. If the value that the wafer 2 is regarded as cleaned to the proper clean state is set small to the state that the differential value sweeps as shown in FIG. 3, it becomes very difficult to hold the value for equal to or more than 5 seconds even if the value is equal to or less than 0.05 MΩcm/sec. Further, it may become impossible to prolong the wafer 2 cleaning time, and finish rinsing the wafer 2 with ultra-pure water. Therefore, it is necessary to set the differential value of resistivity at white the wafer 2 is regarded as cleaned to the proper clean state to the value that the wafer 2 cleaning time becomes the shortest within the range satisfying the cleanness demanded for the wafer 2.

Because of the above reason, in the embodiment shown in FIG. 3, when the differential value of resistivity is held equal to or less than 0.05 MΩcm/sec for equal to or more than 5 seconds after passing the maximum value for all the four kinds, the wafer 2 is regarded as cleaned to the proper clean state, and the rinsing of the wafer 2 is finished. By this method, the final rinsing of the wafer 2 can be finished in substantially the same state, even if the resistivity of the solution 6 in the cleaning tank 3 is different for the processing conditions in cleaning with a chemical solution. Namely, stains such as chemical solution adhered to the wafer 2 can be sufficiently eliminated and the wafer 2 can be cleaned to substantially the same clean state in various conditions, regardless of the number of wafers 2 to be cleaned, the kinds and density of cleaning chemical solution, or the resistivity of the solution 6 in the cleaning tank 3. As shown in FIG. 3, in this embodiment, the wafer 2 can be cleaned to the proper clean state and the final rinsing can be finished within about 7 to 8 minutes for all of the four kinds of cleaning solution.

Next, a brief explanation will be given on an example comparative to the above embodiment with reference to FIG. 7. FIG. 7 is a graph showing the relationship between the wafer rinsing time (cleaning time) and resistivity according to a prior art, with respect to the kinds of cleaning chemical solution and the number of wafers to be cleaned. Concretely, the graph of FIG. 7 indicates the resistivity measured by the wafer cleaning method and the cleaning equipment 101 according to the prior art shown in FIG. 5A, under the four conditions of HF200/1wf, HF500/1wf, HF200/44wf and HF500/44wf, as in the embodiment described above. The solid line in the graph of FIG. 7 indicates the changes in the resistivity with respect to the ultra-pure water rinsing time in HF200/1wf, or the resistivity recovery time. The dashed line in the graph of FIG. 7 indicates the changes in the resistivity with respect to the ultra-pure water rinsing time in HF500/1wf, or the resistivity recovery time. The chain line in the graph of FIG. 7 indicates the changes in the resistivity with respect to the ultra-pure water rinsing time in HF200/44wf, or the resistivity recovery time. The chain double-dashed line in the graph of FIG. 7 indicates the changes in the resistivity with respect to the ultra-pure water rinsing time in HF500/44wf, or the resistivity recovery time.

According to the prior art, whether a wafer is cleaned to the proper clean state is determined by whether the resistivity of solution reaches a preset value. In this comparative example, when the resistivity of solution reaches 16 MΩcm, a wafer is regarded as cleaned to the proper clean state. Among the four conditions, in HF200/44wf and HF500/44wf for rinsing 44 wafers, the ultra-pure water rinsing time is different according to the density of chemical solution (hydrofluoric acid). The resistivity of the solution reaches 16 MΩcm in both conditions. Therefore, in HF200/44wf and HF500/44wf, the end time of final wafer rinsing can be determined (confirmed) also in the above setting. Contrarily, in HF200/1wf and HF500/1wf for rinsing 1 wafer, the ultra-pure water rinsing time is different according to the density of chemical solution, and the resistivity of the solution does not reach 16 MΩcm. Therefore, in HF200/1wf and HF500/1wf, the end time of final wafer rinsing can not be determined (confirmed) in the above setting.

The resistivity of the solution at which a wafer is regarded as cleaned to the proper clean state is set to 13 MΩ, for example, so as to determine the end time of final wafer rinsing even in HF200/1wf and HF500/1wf. Then, the final wafer rinsing can be finished when the resistivity of the solution reaches 13MΩcm I HF200/1wf and HF500/1wf. However, in HF200/44wf and HF500/44wf, when the resistivity of the solution reaches 13 MΩcm, the ion contained in the chemical solution remains in the solution in the cleaning tank. Namely, in HF200/44wf and HF500/44wf, if the resistivity of the solution at which a wafer is regarded as cleaned to the proper clean state is set to 13 MΩcm, the final rinsing will be finished before a wafer is sufficiently rinsed.

Therefore, in the prior art, the wafer rinsing time is set long including a sufficient allowance considering variations of the rinsing time due to the cleaning conditions, so as to clean a wafer to the sufficiently cleaned state, regardless of the various conditions such as the number of wafers, the kinds and density of cleaning chemical solution, and the resistivity of the solution in the cleaning tank. For example, in the comparative example shown in. FIG. 7, the rinsing time is generally set to about 10 minutes. On the contrary, in the above-mentioned embodiment, as seen from FIG. 3, the wafer 2 can be cleaned to the proper clan state in 7-8 minutes in all of the four conditions, and the final rinsing can be finished.

For example, under the condition of HF500/44wf, the prior art can reduce the rinsing time by about 200 seconds by applying this embodiment to the cleaning tank that requires about 600 seconds (10 minutes) for rinsing a wafer. In this case, if the flow rate per unit time of ultra-pure water supplied to the cleaning tank is set to about 20 L/min, the ultra-pure water can be decreased by about 67 liters. The rinsing time is about 70 seconds different between HF200/1wf with the longest rinsing time and HF500/44wf with the shortest rinsing time in the above example. Namely, according to this embodiment, the rinsing time can be decreased by about 70 seconds in HF500/44wf compared with HF200/1wf. In this case, if the flow rate per unit time of ultra-pure water supplied to the cleaning tank 3 is set to about 20 L/min, the ultra-pure water can be decreased by about 23 liters. On the contrary, in the prior art, the rinsing time is set to about 600 seconds for both HF200/1ef and HF500/44wf, as described above. Therefore, in the prior art, about 70 seconds of rinsing time and about 23 liters of ultra-pure water are wasted in HF500/44wf.

The resistivity recovery time in the final rinsing of the wafer 2 is easy to be influenced by the number of wafers 2, and the kinds and density of chemical solution. The resistivity recovery time is not even. Therefore, in the prior art, the wafer rinsing time is determined considering the longest rinsing time. Contrarily, in this embodiment, even if the wafer 2 cleaning condition is different, the wafer 2 can be cleaned to the same state while controlling a waste of ultra-pure water, and the wafer rinsing can be finished. Namely, according to this embodiment, the wafer 2 can be cleaned to substantially the same proper clean state regardless of the wafer 2 cleaning conditions. Compared with the prior art, this embodiment Cal also improve the wafer 2 cleaning efficiency by decreasing the volume of ultra-pure water and reducing the row process time (RPT) of the wafer 2.

Further, this embodiment uses the time differential value of resistivity. This corresponds to using the replacement of chemical solution by ultra-pure water. Therefore, this is difficult to be influenced by a final resistivity value attained by the resistivity of the solution 6 in the cleaning tank 3 when the wafer 2 is cleaned with ultra-pure water. Namely, this embodiment is little influenced by the final resistivity difference caused by the different number of wafers 2 to be cleaned, and the lowered final resistivity caused by deterioration of the measuring accuracy of a resistivity meter.

According to the first embodiment, the rinsing of wafer 2 is finished at the point when the time differential values of the resistivity of the chemical solution used for cleaning the wafer 2 and the solution 6 including the cleaning water used for rinsing the cleaned wafer 2 are equal to or less than preset values, and held at that values for preset time. This makes it possible to clean the wafer 2 to the proper clean state while improving the wafer 2 cleaning efficiency, regardless of the number of wafers 2 to be cleaned and the kinds and density of the chemical solution used for cleaning.

The wafer 2 according to this embodiment has been rinsed by the wafer cleaning method or the wafer cleaning equipment 1 according to this embodiment. Therefore, the wafer 2 of this embodiment has been cleaned to the proper clean state with stains of chemical solution removed sufficiently. Further, the wafer 2 of this embodiment provides high yield (production efficiency), and reduces the production cost.

In addition, thought not shown, the semiconductor device according to this embodiment has the wafer 2 according to this embodiment. Therefore, the semiconductor device of this embodiment is improved in the performance, quality, reliability and yield. Further, the semiconductor device of this embodiment provides high production efficiency, and reduces the production cost.

### 2nd. Embodiment

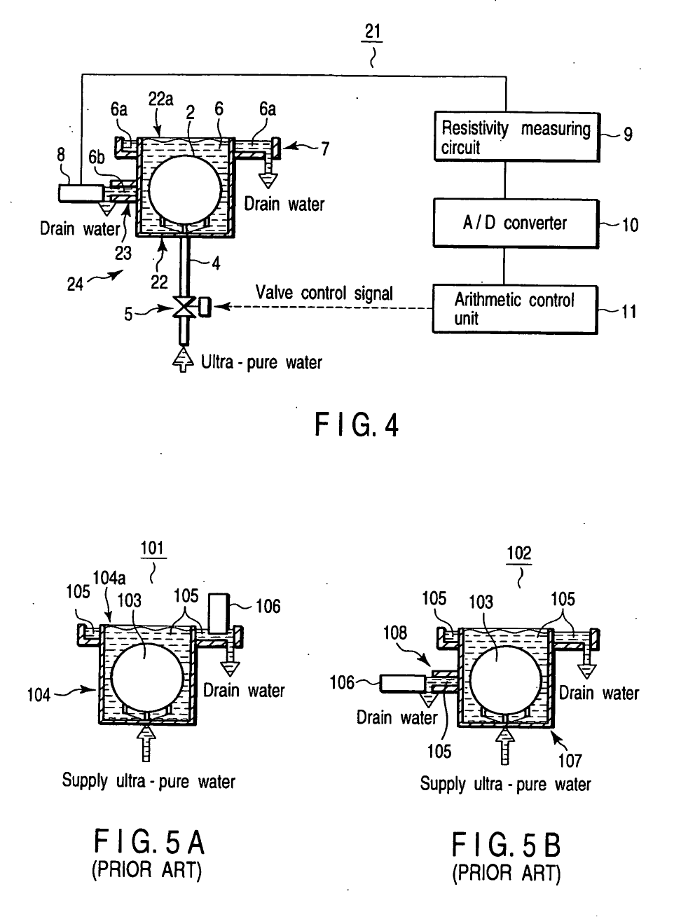

Now, explanation will be given on a second embodiment of the present invention with reference to FIG. 4. FIG. 4 is a simplified block diagram showing a wafer cleaning equipment according to this embodiment. The same reference numerals are given to the same components as in the first embodiment, and a detailed explanation will be omitted.

Unlike the wafer cleaning equipment according to the first embodiment, in the wafer cleaning equipment according to this embodiment, a resistivity meter (resistivity measuring cell) is provided near the middle part of a cleaning tank. Concrete explanation will be given below.

As shown in FIG. 4, in the middle part of a cleaning tank 22 of a wafer cleaning equipment 21 according to this embodiment, a take-out port (solution extraction port) 23 is provided to take out the solution 6 from the cleaning tank 22 without exposing to the air. A resistivity meter (resistivity measuring cell) 8 is provided contacting the solution 6b taken out from the cleaning tank 3 through the solution extraction port 23. Namely, in this embodiment, the resistivity measuring cell 8 is set to measure the resistivity of the solution 6b without contacting the air.

The wafer cleaning method, wafer, and semiconductor device according to this embodiment are the same as those of the first embodiment, and explanation will be omitted.

The second embodiment can provide the same effects as the first embodiment. In this embodiment, the resistivity measuring cell 8 measures the resistivity of the solution 6b without contacting the air. Therefore, the measured value is difficult to be influenced by the carbonic acid gas or the like in the air dissolved in the solution 6 through an upper opening 22a of the cleaning tank 22 as a result of so-called air involving. Namely, the measured value of the resistivity in this embodiment is difficult to be influenced by the noises occurred in a cleaning system 24 of the cleaning equipment 21 comprising the cleaning tank 22, water supply pipe 4, and ultra-pure water supply valve 5. Particularly, the measured value is difficult to be influenced by the changes in the noises in the cleaning system 24 caused by the changes in the air contacting area of the solution 6 as a result of the surface fluctuation of the solution 6. Therefore, this embodiment can measure the resistivity of the solution 6 with a high accuracy, and clean the wafer 2 to more clean state. Namely, stains such as chemical solution adhered to the wafer 2 of this embodiment are sufficiently eliminated, and the wafer 2 is cleaned to more proper clean state. Further, though not shown, the semiconductor device of this embodiment is improved in the performance, quality, reliability and yield.

The cleaning method and equipment according to the present invention are not limited to the first and second embodiments. The invention may be embodied in other specific forms without departing from its spirit or essential characteristics modifications. The configurations and processes of the embodiments may be partially modified, or combined appropriately.

For example, the A/D converter 10 is provided between the resistivity measuring circuit 9 and arithmetic control circuit 11 in the first and second embodiments, but the A/D converter 10 is not always necessary. If the resistivity measuring circuit 9 and arithmetic control circuit 11 are set to process the same form analog or digital signal, the A/D converter 10 is unnecessary.

The arithmetic section (arithmetic circuit) and control section (control circuit) of the arithmetic control unit 11 are constructed as one body, but they may not necessarily be one body. The arithmetic section and control section of the arithmetic control unit 11 may be configured as separate independent units.

The resistivity measuring cell 8 is not necessary provided near the upper opening 3a of the cleaning tank 3 or at the middle of the cleaning tank 2. If the solution extracted to the resistivity cell 8 is not replaced from a chemical solution to pure water before the atmosphere solution of wafer 2, the resistivity measuring cell 8 may be provided near the bottom of the cleaning tanks 3 and 22. In this setting, the measured value of the resistivity of the solution 6 is more difficult to be influenced by the noises occurred in the cleaning systems 12 and 24 caused by the carbonic acid gas dissolved in the solution 6.

The cleaning tanks 3 and 22 may be either a so-called batch type capable of cleaning a plurality of wafers 2 at one time, or a single wafer type for cleaning the wafer 2 one by one.

As a representative noise in the cleaning systems 12 and 24, there is carbonic acid gas such as carbon dioxide in the air dissolved in the solution 6. The carbonic acid gas dissolved in the solution 6 affects largely the resistivity even if the dissolved amount is very small. The amount of the carbonic acid gas dissolved in the solution 6 is changed by the speed of supplying ultra-pure water to the cleaning tanks 3 and 22, the speed of draining the solution 6 from the cleaning tanks 3 and 22, or the changes in the air contact area of the solution 6 by the surface fluctuation of the solution 6. The change rate of the dissolved amount of carbonic acid gas is largely influenced by the shapes of the cleaning tanks 3 and 22, the sizes of the upper openings 3a and 22a, or the installation method and position of the resistivity measuring cell 8. Therefore, the method of smoothing the resistivity values to eliminate the noises in the cleaning systems 12 and 24 is not limited to the weighted average (the weighted smoothing), a weighted mean, or the Savizky-Golay method. Any method suitable for the noises in the cleaning systems 12 and 24 may be used.

Actually, the noise components cannot be completely eliminated only by smoothing the resistivity values. Thus, the differential value of resistivity that the wafer 2 is regarded as cleaned to the proper clean state Is not necessarily limited to 0.05 MΩm/sec. Any value equal to or less than 0.05 MΩcm/sec is usable as a differential value of resistivity that the wafer 2 is regarded as cleaned to the proper clean state.

In the first and second embodiments, the conditions that the wafer 2 is regarded as cleaned to the proper clean state that the differential value of resistivity is equal to or less than 0.05 MΩcm/sec after passing the maximum value and held at that value for equal to or more than 5 seconds, but the conditions are not necessarily limited to them. The conditions that the wafer 2 is regarded as cleaned to the proper clean state may be determined to appropriate values according to the number of wafers 2 to be cleaned, the sizes of the processing tanks 3 and 22, the shapes of the openings 3a and 22a, or the kinds and density of the chemical solution used for the cleaning with a chemical solution, and other various conditions.

In the first and second embodiment, ultra-pure water as a cleaning water is supplied to the cleaning tanks 2 and 22 from the bottom, but the setting is not limited to this. Ultra-pure water may be supplied from the middle of the cleaning tanks 3 and 22. If the ultra-pure water is exposed to the air when it is supplied to the cleaning tanks 3 and 22 through the upper openings 3a and 22a, for example, air involving occurs and the carbonic acid gas or the like in the air is dissolved in the ultra-pure water. The carbonic acid gas or the like dissolved in the ultra-pure water causes a noise component in the cleaning systems 12 and 24 when measuring the resistivity and conductivity of the solution 6, and the measuring accuracy is lowered. Contrarily, if ultra-pure water is supplied directly to the cleaning tanks 3 and 22 from the bottom or the middle part without exposing to the air, the possibility of dissolving carbonic acid gas or the like in the ultra-pure water will be eliminated to almost zero. Namely, the noise components in the cleaning systems 12 and 24 can be controlled and the accuracy of measuring the resistivity and conductivity of the solution 6 can be improved. Further, the wafer 2 can be cleaned to more clean state while improving the cleaning efficiency.

In the first and second embodiments, the cleaning tank 3 is either a processing tank dedicated to rinsing the wafer 2 with adhesion of a cleaning chemical solution, or a processing tank provided with a device to switch the solution supplied to the wafer 2 from a chemical solution to cleaning water after the wafer 2 is cleaned with a chemical solution. By using the cleaning tanks 3 and 22 as a processing tank dedicated to rinsing, the volume of chemical solution to be eliminated by a cleaning water can be decreased. Thus, compared with the case that the cleaning tanks 3 and 22 are used as a processing tank not dedicated to rinsing, the wafer 2 cleaning efficiency can be improved furthermore.

In the first and second embodiments, the resistivity of the solution 6 is measured by using the resistivity measuring cell 8, but the measurement is not limited to this. It is allowed to measure the conductivity of the solution 6 instead of the resistivity. In this case, a conductivity meter may be used instead of the resistivity measuring cell 8 (a resistivity meter) as an electric characteristic measuring unit. Cleaning of the wafer 2 with the cleaning water may be continued until reaching the condition that the time differential value of the conductivity of the solution 6 becomes larger than a preset value and is held at that value for preset time. Concretely, the cleaning of the wafer 2 with the cleaning water may be continued until the time differential value of the conductivity of the solution becomes equal to or more than −20 μS/cm·sec after passing the minimum value and is held at that value for equal to or more than 5 seconds.

Generally, the time differential value of the conductivity of the solution including the chemical solution used for cleaning a wafer and the cleaning water used for cleaning a wafer are substantially zero at the start of measurement, regardless of the number of wafers to be cleaned and the kinds and density of the chemical solution used for the cleaning. The time differential value of the conductivity descends as the measurement time elapses and reaches the peak at preset time. Thereafter, the time differential value of the conductivity ascends as the measurement time elapses and becomes substantially zero. Namely, the value obtained by differentiating the conductivity with respect to time traces a curve projecting downward, regardless of the number of wafers to be cleaned and the kinds and density of the chemical solution used for the cleaning.

When using the time differential value of the conductivity of solution to determine the wafer cleaning time, use the features of the time differential value of the conductivity. Namely, continue cleaning a wafer until the time differential value of the conductivity of cleaning solution becomes larger than a preset value determined based on the experiment data at which a wafer can be cleaned to the proper clean state, and is held at that value for preset time. Thus, the wafer cleaning with a cleaning water can be finished immediately after a wafer is cleaned to the proper clean state. As a result, the cleaning water volume used for cleaning a wafer can be decreased, and a wafer can be cleaned to the proper clean state while reducing the wafer cleaning time, regardless of the number of wafers to be cleaned and the kinds and density of the cleaning solution used for the cleaning.

Like the time differential value of the resistivity of the cleaning solution, the time differential value of the conductivity of the solution is not necessarily limited to −20 μS/dm sec. Any values equal to or more than −20 μS/cm·sec may be used as the differential value of the conductivity at which the wafer 2 is regarded as cleaned to the proper clean state. The conditions that the wafer 2 is regarded as cleaned to the proper clean state are also not necessarily limited to that the differential value of the conductivity is equal to or more than −20 μS/cm·sec after passing the minimum value, and is held at that value for equal to or more than 5 seconds. The conditions that the wafer 2 is regarded as cleaned to the proper clean state may be determined to an appropriate value according to the number of wafers 2 to be cleaned, the size of the processing tanks 3 and 22, the shapes of the openings 3a and 22a, the kinds and density of the chemical solution used for the cleaning, and other various conditions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

This application is a divisional of application Ser. No. 10/932,006, filed on Sep. 2, 2004, which claims the benefit of priority to Japanese Patent Application No. 2003-314513, filed on Sep. 5, 2003, the contents of all of which are incorporated herein by reference in their entireties.

1. A wafer cleaning method comprising:
supplying a cleaning water to a wafer cleaned with a chemical solution;
measuring the resistivity of a solution including the chemical solution and cleaning water, and differentiating the measured value with respect to time; and
cleaning the wafer continuously with the cleaning water until the time differential value of the resistivity becomes equal to or less than a preset value and is held at that values time differential value for a preset time.

2. The method according to claim 1, wherein the wafer is cleaned continuously with the cleaning water until the time differential value of the resistivity becomes equal to or less than 0.05 MΩcm/sec after passing the preset value, and is held at that time differential value for equal to or more than 5 seconds.

3. The method according to claim 1, wherein the resistivity of the solution is subjected to a predetermined smoothing, and the smoothed value is differentiated with respect to time.

4. The method according to claim 1, wherein the resistivity of the solution in the cleaning tank which contains the wafer when cleaning the wafer with the cleaning water is measured as the resistivity of the solution.

5. A wafer cleaning method comprising:
supplying a cleaning water to a wafer cleaned with a chemical solution;
measuring the conductivity of a solution including the chemical solution and cleaning water, and differentiating the measured value with respect to time; and
cleaning the wafer continuously with the cleaning water until the time differential value of the conductivity becomes equal to or more than a preset value and is held at that time differential value for a preset time.

6. The method according to claim 5, wherein the wafer is cleaned continuously with the cleaning water until the time differential value of the conductivity becomes equal to or more than −20 μS/cm·sec after passing the preset value, and is held at that time differential value for equal to or more than 5 seconds.

7. The method according to claim 5, wherein the conductivity of the solution is subjected to a predetermined smoothing, and the smoothed value is differentiated with respect to time.

8. The method according to claim 5, wherein the conductivity of the solution in the cleaning tank which contains the wafer when cleaning the wafer with the cleaning water is measured as the conductivity of the solution.

9-16. (canceled)
